(19) United States
(12) Patent Application Publication
(10) Pub. No.: US 2026/0290775 A1
(43) Pub. Date: Sep. 24, 2026

(54) SAMPLE SUPPORT AND METHOD FOR MANUFACTURING SAMPLE SUPPORT

(71) Applicant: HAMAMATSU PHOTONICS K.K., Hamamatsu-shi, Shizuoka (JP)

(72) Inventor: Takamasa IKEDA, Shizuoka (JP)

(73) Assignee: HAMAMATSU PHOTONICS K.K., Hamamatsu-shi, Shizuoka (JP)

(21) Appl. No.: 19/490,129

(22) PCT Filed: Jan. 12, 2024
(86) PCT No.: PCT/JP2024/000685

§ 371 Date: Dec. 4, 2025

(30) Foreign Application Priority Data
Jun. 7, 2023 (JP) 2023-093795

(51) Int. Cl. H01J 49/04; H01J 9/30; H01J 49/16

(52) U.S. Cl. CPC H01J 49/0409; H01J 9/30; H01J 49/165

(57) ABSTRACT

A sample support of an embodiment is a sample support for ionization of a sample. The sample support includes a substrate having a first surface, a second surface opposite to the first surface, and an irregular porous structure opening to at least the first surface. The porous structure is formed by a plurality of particles connected to each other. Particles of the plurality of particles that constitute the first surface have a rough surface on which an uneven structure is formed on a first surface side, and a non-rough surface on which the uneven structure is not formed on a second surface side.

### TECHNICAL FIELD

The present disclosure relates to a sample support and a method for manufacturing the sample support.

### BACKGROUND ART

Desorption Electrospray Ionization (DESI) is known as a method for ionizing a sample such as a biological sample. Also, as a sample support suitable for such a desorption electrospray ionization method, a sample support including a substrate having a first surface, a second surface opposite to the first surface, and an irregular porous structure opening to at least the first surface is known (see, for example, Patent Literature 1). In the sample support, for example, a sample transferred onto the first surface is irradiated with charged micro-droplets, whereby desorption and ionization of the sample are performed.

### CITATION LIST

### Patent Literature

Patent Literature 1: JP 2022-43571 A

### SUMMARY OF INVENTION

### Technical Problem

In the sample support as described above, it is required to improve the detection sensitivity of a component of a sample in mass spectrometry or the like using an ionization method such as the above-described desorption electrospray ionization method.

An object of the present disclosure is to provide a sample support and a method for manufacturing the sample support, which can effectively improve the detection sensitivity of a component of a sample.

### Solution to Problem

The present disclosure includes the following sample supports [1] to [7] and a method for manufacturing a sample support [8].
[1] A sample support for ionization of a sample, including: a substrate having a first surface, a second surface opposite to the first surface, and an irregular porous structure opening to the first surface, wherein the porous structure is formed by a plurality of first particles connected to each other, and outermost first particles of the plurality of first particles, which constitute the first surface, have a rough surface on which an uneven structure is formed on a first surface side, and a non-rough surface on which the uneven structure is not formed on a second surface side.

In the sample support of [1] described above, the outermost first particles of the plurality of first particles constituting the porous structure (that is, the first particles located in the outermost layer on the first surface side) have a rough surface on which an uneven structure is formed on the first surface side. By providing such an uneven structure, a sample to be measured can be suitably retained on the rough surface. On the other hand, a surface of the outermost first particles opposite to the rough surface is a non-rough surface on which the uneven structure is not formed. This allows excess liquid components contained in the sample to be suitably permeated from the first surface side to the second surface side. As a result, it is possible to suppress the measurement (ionization of the component of the sample retained on the first surface) from being hindered by an excess liquid component overflowing on the first surface. Therefore, according to the sample support of [1] described above, since a component of the sample retained on the first surface can be efficiently ionized, the detection sensitivity of the component of the sample can be effectively improved.
[2] The sample support according to [1], wherein the porous structure further comprises a plurality of second particles each having a diameter smaller than that of the first particles, and at least a part of the plurality of second particles is held between two or more of the outermost first particles.

In the configuration of [2] described above, the porous structure includes not only the plurality of first particles but also the second particles held between two or more of the outermost first particles. This can reduce a gap (that is, a space where no particles constituting the porous structure exist) of the sample support on the first surface when the sample support is viewed from a position facing the first surface. In addition, on the first surface, not only joints between the first particles but also joints between the first particles and the second particles, and joints between the second particles are added. This allows a sample to be measured to be more suitably retained on the first surface (particularly on the joints described above). As a result, the detection sensitivity of the component of the sample can be more effectively improved.
[3] The sample support according to [2], wherein outermost second particles of the plurality of second particles, which constitute the first surface, have a rough surface on which the uneven structure is formed on a first surface side, and a non-rough surface on which the uneven structure is not formed on a second surface side.

According to the configuration of [3] described above, not only the outermost first particles but also surfaces on the first surface side of the outermost second particles located between two or more of the outermost first particles are configured as rough surfaces, so that the sample to be measured can be more suitably retained on the first surface. As a result, the detection sensitivity of the component of the sample can be more effectively improved.
[4] The sample support according to [2], wherein the uneven structure is formed on neither a surface on a first surface side nor a surface on a second surface side of outermost second particles of the plurality of second particles that constitute the first surface.

The configuration of [3] described above is obtained, for example, by performing a treatment similar to the roughening treatment on the surface of the first particles also on the surface (the surface on the first surface side) of the second particles, which have a smaller diameter than the first particles. Here, since the second particles are smaller and more brittle than the first particles, the second particles may be crushed in the roughening treatment. As a result, the effect of [2] described above may be reduced. In contrast, according to the configuration of [4] described above, since the roughening treatment is performed only on the surface of the first particles, the above-described problem can be avoided.
[5] The sample support according to any one of [2] to [4], wherein the substrate includes: a first layer including the first surface and in which a plurality of the first particles and a plurality of the second particles coexist; and a second layer located closer to the second surface than the first layer, consisting of a plurality of the first particles, and not including the second particles.

In the configuration of [5] described above, while the first layer in which the first particles and the second particles coexist is provided to easily retain the sample on the first surface, the second layer, through which a liquid can pass more easily than the first layer by not including the second particles, is provided below the first layer (on the second surface side). This can suppress the measurement (ionization of the component of the sample retained on the first surface) from being hindered by an excess liquid component overflowing on the first surface, for example, when a sample to be measured containing a liquid component is transferred or dropped onto the first surface of the sample support.
[6] The sample support according to any one of [1] to [5], wherein particles of the plurality of first particles that constitute the second surface have a rough surface on which an uneven structure is formed on a second surface side, and a non-rough surface on which the uneven structure is not formed on a first surface side.

According to the configuration of [6] described above, both the first surface and the second surface can be used as a measurement surface (that is, a surface that supports the sample to be measured) that exhibits the effect of [1] described above. This improves convenience because a user (measurer) of the sample support does not need to identify which surface of the sample support is the measurement surface when transferring or dropping the sample to be measured onto the sample support.
[7] The sample support according to any one of [1] to [6], further including a conductive layer that covers the first surface along a surface shape of the uneven structure of the outermost first particles without blocking openings of the porous structure on the first surface.

According to the configuration of [7] described above, the sample support can be used for a laser desorption/ionization method or the like without impairing the effect of [1]. More specifically, when a laser desorption/ionization method or the like is used, that is, when it is necessary to apply a voltage to the first surface to guide the component of the sample ionized on the first surface to an ion detector (ground electrode), a voltage can be appropriately applied via the conductive layer.
[8] A method for manufacturing the sample support according to any one of [1] to [7], including: a sintering step of sintering the plurality of first particles to obtain a sintered body having substantially same outer shape as the substrate; and a roughening step of performing a roughening treatment on a surface of the sintered body corresponding to the first surface, thereby forming a plurality of the outermost first particles, each having the rough surface formed on the first surface side.

According to the manufacturing method of [8] described above, by sequentially performing a sintering treatment and a roughening treatment on the plurality of first particles, the sample support exhibiting the effect of [1] described above can be easily and stably obtained.

### Advantageous Effects of Invention

According to the present disclosure, it is possible to provide a sample support and a method for manufacturing the sample support, which can effectively improve the detection sensitivity of a component of a sample.

### BRIEF DESCRIPTION OF DRAWINGS

FIG. 1 is a perspective view showing a sample support of an embodiment.

FIG. 2 is an SEM image of a region A shown in FIG. 1.

FIG. 3 is a diagram schematically showing a portion including the outermost particles of the sample support of FIG. 1.

FIG. 4 is an SEM image showing a cross section of the sample support of FIG. 1.

FIG. 5 is an enlarged view of a part of the SEM image shown in FIG. 4.

FIG. 6 is a diagram showing a second step in a mass spectrometry method using the sample support of FIG. 1.

FIG. 7 is a diagram showing a configuration example of a mass spectrometer that performs the mass spectrometry method.

FIG. 8 is a diagram showing an example of an irradiation region of micro-droplets in an example and a comparative example.

FIG. 9 is a diagram showing a measurement result of detection sensitivity per irradiation region in the example and the comparative example.

FIG. 10 is an SEM image of a part of a sample support according to a first modification, viewed from a position facing a first surface.

FIG. 11 is a diagram schematically showing an arrangement example of particles constituting the first surface of the first modification.

FIG. 12 is a diagram schematically showing a layer structure of the sample support according to the first modification.

FIG. 13 is a diagram schematically showing an arrangement example of particles constituting a first surface of a second modification.

FIG. 14 is a diagram schematically showing a layer structure of a sample support according to a third modification.

FIG. 15 is a diagram schematically showing a portion including outermost particles of the sample support according to the third modification.

### DESCRIPTION OF EMBODIMENTS

Hereinafter, embodiments of the present disclosure will be described in detail with reference to the drawings. In the drawings, the same or corresponding parts are denoted by the same reference numerals, and redundant description will be omitted.

### [Sample Support]

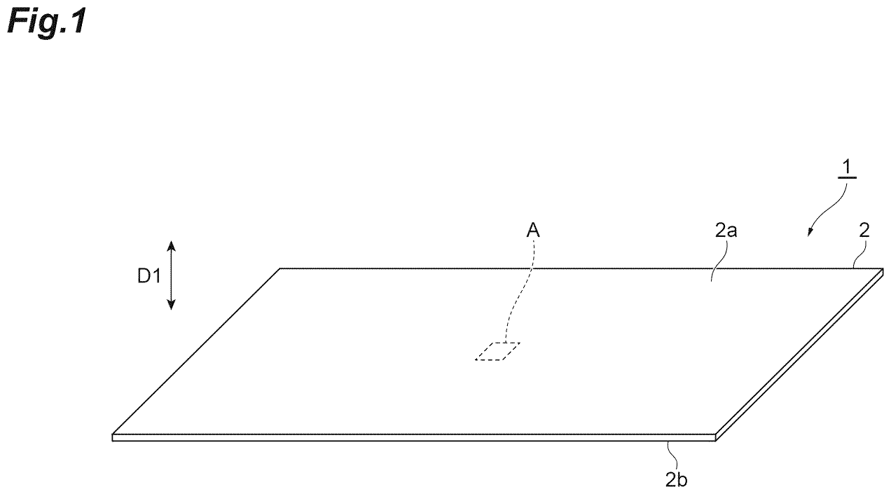

As shown in FIG. 1, a sample support 1 includes a substrate 2. As an example, the substrate 2 is formed in a rectangular plate shape. The substrate 2 has a first surface 2a and a second surface 2b opposite to the first surface 2a. The first surface 2a has insulating properties (electrical insulating properties). In the present embodiment, the substrate 2 is an insulating member. Therefore, not only the first surface 2a but also the entire substrate 2 has insulating properties. The first surface 2a functions as a measurement surface on which a sample to be measured is transferred or dropped. The thickness of the substrate 2 (distance from the first surface 2a to the second surface 2b) is, for example, about 100 μm to 1500 μm.

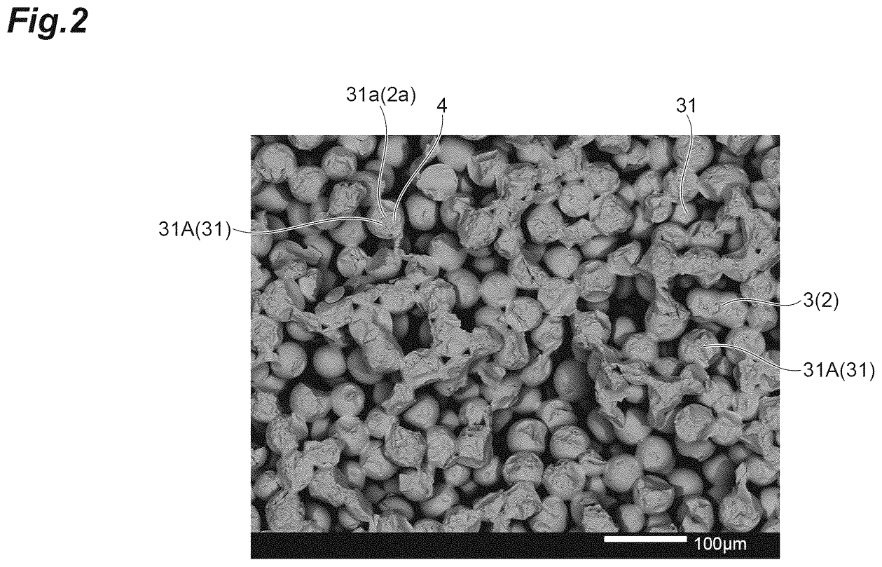

FIG. 2 is an SEM image obtained by capturing the sample support 1 (the substrate 2 made of the porous structure 3) from a direction facing the first surface 2a. As shown in FIG. 2, an irregular porous structure 3 opening to the first surface 2a is formed in the substrate 2. In the present embodiment, the entire substrate 2 is formed of the porous structure 3. Here, the “irregular porous structure” is, for example, a structure in which voids (pores) extend in irregular directions and are irregularly distributed in three dimensions. For example, a structure that enters the substrate 2 from one inlet (opening) on the first surface 2a side and branches into a plurality of paths, or a structure that enters the substrate 2 from a plurality of inlets (openings) on the first surface 2a side and merges into one path is also included in the irregular porous structure. On the other hand, for example, a structure in which a plurality of pores extending along a thickness direction of the substrate 2 (that is, a direction D1 in which the first surface 2a and the second surface 2b face each other) from the first surface 2a to the second surface 2b are provided as main pores (that is, a regular structure mainly configured by pores extending in one direction) is not included in the irregular porous structure.

The porous structure 3 is formed of an aggregate of a plurality of particles 31 (first particles). The aggregate of a plurality of particles 31 is a structure in which a plurality of particles 31 are gathered so as to be in contact with each other. That is, the porous structure 3 is formed by a plurality of particles 31 connected to each other. An example of the aggregate of a plurality of particles 31 is a structure in which a plurality of particles 31 are joined or bonded to each other. That is, in order to form a structure in which a plurality of particles 31 are fixed in contact with each other, the plurality of particles 31 may be directly connected by fusion or the like, or may be indirectly connected via another member. In the present embodiment, a plurality of particles 31 are joined by fusion. In the present embodiment, the particles 31 are formed of an insulating material. For example, the particles 31 are formed of glass. In the present embodiment, from the viewpoint of facilitating the manufacture of the aggregate structure, soda glass having a relatively low melting point among glasses is used as the material of the particles 31. The particles 31 are formed in a spherical shape. Examples of such spherical particles 31 include glass beads and the like.

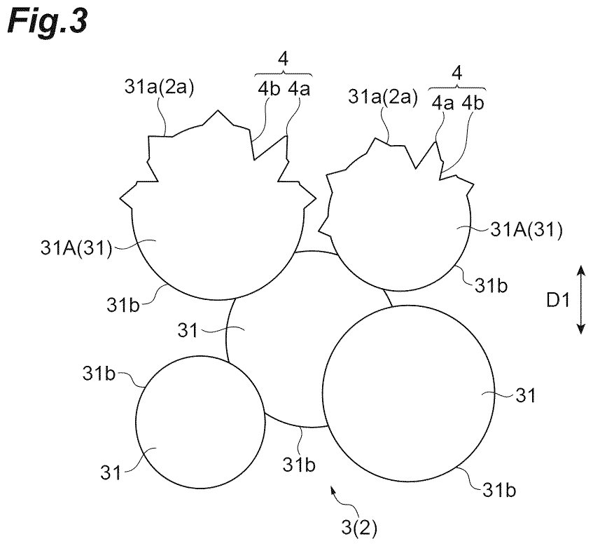

As shown in FIG. 3, particles 31A (outermost first particles) of the plurality of particles 31 that constitute the first surface 2a have a rough surface 31a on a first surface 2a side (upper side in FIG. 3) and a non-rough surface 31b on a second surface 2b side (lower side in FIG. 3). The particles 31A constituting the first surface 2a are the particles 31 located in the outermost layer on the first surface 2a side.

The rough surface 31a of the particle 31A is a surface visible when the substrate 2 is viewed along the direction D1 from a position facing the first surface 2a of the substrate 2 (that is, the surface of the particle 31A shown in the SEM image of FIG. 2). A fine uneven structure 4 is formed on the rough surface 31a. The uneven structure 4 is configured by a plurality of convex portions 4a that protrude outward (are pointed) and a plurality of concave portions 4b that are recessed inward. The plurality of convex portions 4a and the plurality of concave portions 4b may be formed regularly or irregularly. For example, the rough surface 31a can be formed by various known roughening treatments for roughening the surface of the particle 31A. Examples of the roughening treatment include a sandblast treatment, a laser processing treatment, etching (dry etching), formation by a mold, and the like. As an example, the rough surface 31a of each of the plurality of particles 31A is formed at the same time by performing a sandblast treatment on the first surface 2a of the substrate 2 in a state before the rough surface 31a is formed on each particle 31A (that is, on the upper surfaces of the plurality of particles 31A). In this case, the uneven structure 4 in which the plurality of convex portions 4a and the plurality of concave portions 4b are irregularly formed is obtained.

The non-rough surface 31b of the particle 31A is a surface not visible when the substrate 2 is viewed along the direction D1 from a position facing the first surface 2a of the substrate 2 (that is, a surface on the back side of the rough surface 31a). The fine uneven structure 4 as formed on the rough surface 31a is not formed on the non-rough surface 31b. That is, the non-rough surface 31b is a smoother surface than the rough surface 31a. The non-rough surface 31b is not affected by the roughening treatment performed from the side facing the first surface 2a as described above, and has the original smooth surface shape (curved surface shape, hemispherical shape) of the particle 31A.

A surface of the particles 31 that do not constitute the first surface 2a (that is, the particles 31 existing inside the substrate 2 (porous structure 3) rather than the particles 31A constituting the outermost layer) is configured by the non-rough surface 31b described above for both the surface on the first surface 2a side and the surface on the second surface 2b side. That is, the surface of the particles 31 existing inside the substrate 2, similar to the back surface (the surface on the second surface 2b side) of the particle 31A, is not affected by the roughening treatment described above, and has the original smooth surface shape (curved surface shape, spherical shape) of the particle 31.

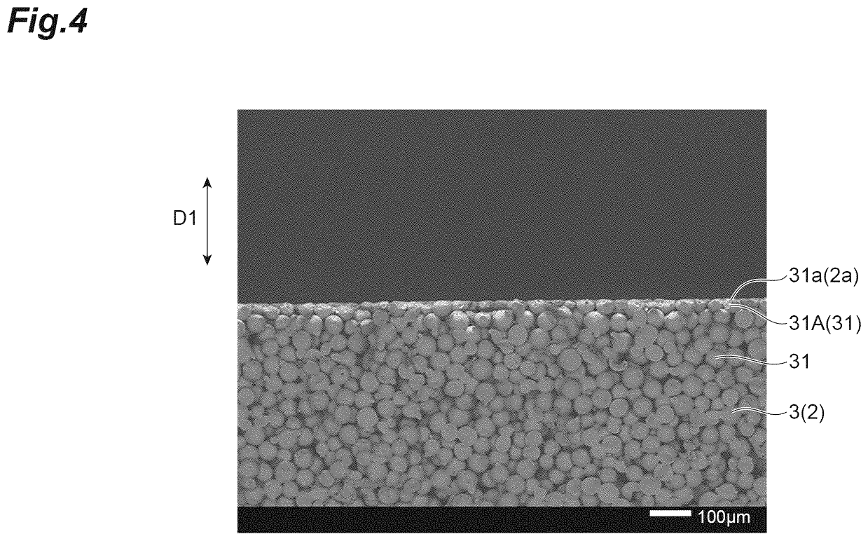

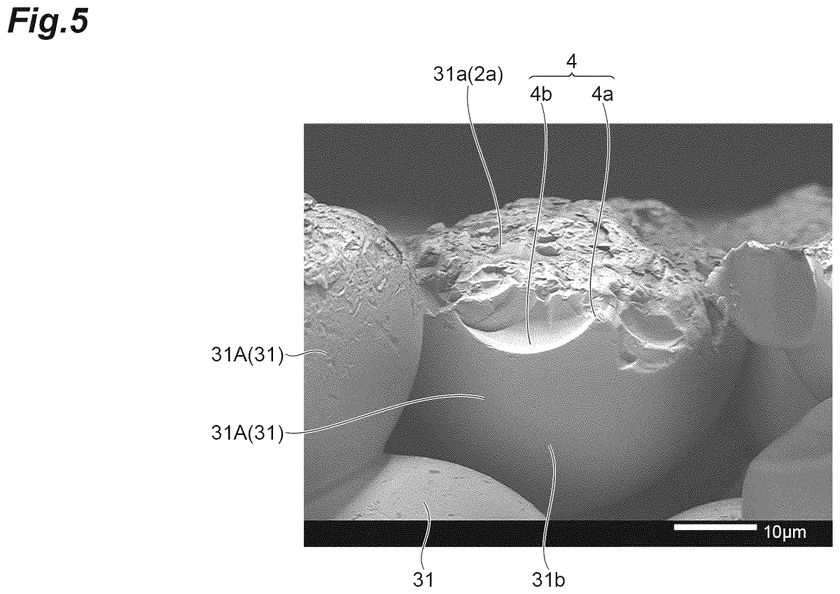

FIG. 4 is an SEM image showing a cross section of the sample support 1. FIG. 5 is an enlarged view of a part of the SEM image of FIG. 4. As shown in FIGS. 2, 4, and 5, although there are slight variations in shape and size for each particle, each of the plurality of particles 31 constituting the porous structure 3 has a substantially uniform size (diameter). Also, from the SEM images of FIGS. 2 and 5, it can be seen that the upper surface of the outermost layer of particles 31A constituting the first surface 2a is configured as the rough surface 31a having the fine uneven structure 4. Also, from the SEM image of FIG. 5, it can be seen that the lower surface of the particle 31A is configured as the non-rough surface 31b having a smooth curved surface shape (hemispherical shape) not including the uneven structure 4. Also, from the SEM image of FIG. 4, it can be seen that the surfaces (upper and lower surfaces) of the particles 31 present inside the substrate 2 are configured as the non-rough surface 31b similar to the lower surface of the particle 31A.

### [Method for Manufacturing Sample Support]

The sample support 1 (porous structure 3) is manufactured, for example, as follows. First, a plurality of particles 31 are sintered to obtain a sintered body (sintering step). Specifically, in a state where the plurality of particles 31 are pressed and compacted by a press machine or the like, the surfaces of the plurality of particles 31 are fused by being heated at a high temperature equal to or lower than the melting point of the particles 31, whereby the particles 31 are bonded to each other, and a sintered body consisting of the plurality of particles 31 is obtained. The sintered body has substantially the same outer shape as the finally obtained substrate 2. Subsequently, the roughening treatment as described above is performed on a surface of the sintered body corresponding to the first surface 2a (that is, a surface scheduled to be the first surface 2a finally) (roughening step). This allows the upper surface of each of the plurality of particles 31A to be the rough surface 31a. As a result, the porous structure 3 described above is obtained.

### [Ionization Method and Mass Spectrometry Method]

An ionization method and a mass spectrometry method using the sample support 1 will be described. First, the sample support 1 described above is prepared as a sample support for ionizing a sample (first step). The sample support 1 may be prepared by being manufactured by a person who performs the ionization method and the mass spectrometry method, or may be prepared by being transferred from a manufacturer, a seller, or the like of the sample support 1.

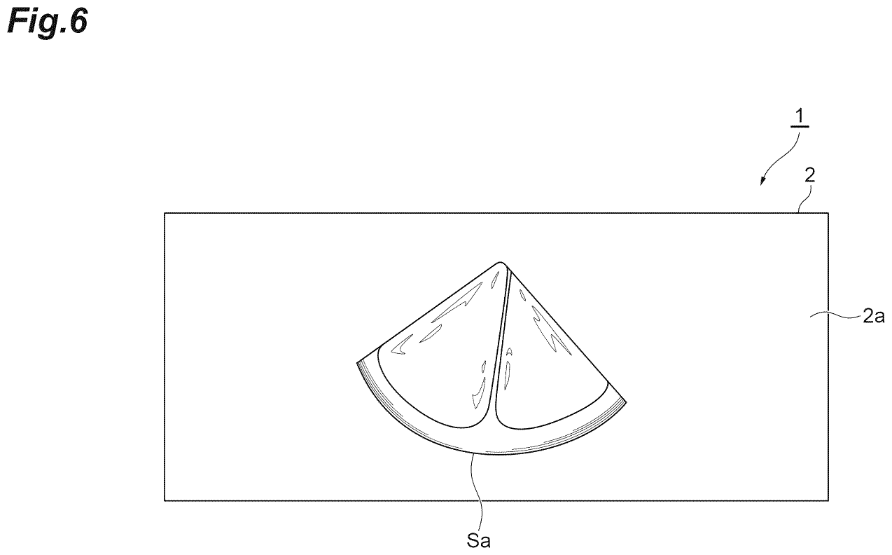

Subsequently, as shown in FIG. 6, a sample Sa is transferred to the first surface 2a of the substrate 2 (second step). In the example of FIG. 6, the sample Sa is a slice of a fruit (lemon). For example, a part of the sample Sa is attached onto the first surface 2a by pressing the sample Sa against the first surface 2a of the substrate 2.

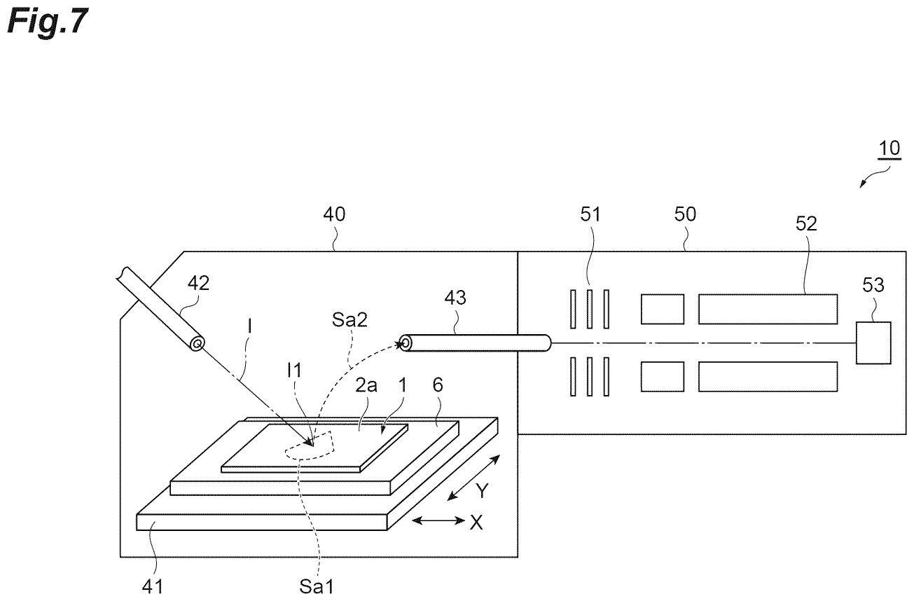

Subsequently, as shown in FIG. 7, a slide glass 6 and the sample support 1 are placed on a stage 41 in an ionization chamber 40 of a mass spectrometer 10. Subsequently, a region including a region where the transferred sample Sa exists on the first surface 2a of the substrate 2 (hereinafter referred to as a “target region”) is irradiated with charged micro-droplets I, thereby ionizing a component Sa1 on the first surface 2a and sucking a sample ion Sa2, which is an ionized component (third step). In the present embodiment, for example, by moving the stage 41 in an X-axis direction and a Y-axis direction, an irradiation region I1 of the charged micro-droplets I is relatively moved with respect to the target region (that is, the target region is scanned with the charged micro-droplets I). The first step, the second step, and the third step described above correspond to an ionization method (in the present embodiment, a desorption electrospray ionization method) using the sample support 1.

In the ionization chamber 40, charged micro-droplets I are ejected from a nozzle 42, and sample ions Sa2 are sucked from a suction port of an ion transport tube 43. The nozzle 42 has a double-tube structure. A solvent is guided to an inner tube of the nozzle 42 in a state where a high voltage is applied. As a result, a biased charge is applied to the solvent that has reached a tip of the nozzle 42. A nebulizing gas is guided to an outer tube of the nozzle 42. As a result, the solvent is sprayed as micro-droplets, and solvent ions generated in the process of vaporizing the solvent are emitted as the charged micro-droplets I.

The sample ions Sa2 sucked from the suction port of the ion transport tube 43 are transported into a mass analysis chamber 50 by the ion transport tube 43. The inside of the mass analysis chamber 50 is under a high vacuum atmosphere (an atmosphere with a degree of vacuum of 10⁻⁴ Torr or less). In the mass analysis chamber 50, the sample ions Sa2 are focused by an ion optical system 51 and introduced into a quadrupole mass filter 52 to which a high-frequency voltage is applied. When the sample ions Sa2 are introduced into the quadrupole mass filter 52 to which the high-frequency voltage is applied, ions having a mass number determined by a frequency of the high-frequency voltage are selectively passed, and the passed ions are detected by a detector 53 (fourth step). By scanning the frequency of the high-frequency voltage applied to the quadrupole mass filter 52, the mass number of ions reaching the detector 53 is sequentially changed to obtain a mass spectrum in a predetermined mass range. In the present embodiment, the detector 53 is caused to detect ions corresponding to the position of the irradiation region I1 of the charged micro-droplets I, and a two-dimensional distribution of molecules constituting the sample Sa is imaged. The first step, the second step, the third step, and the fourth step described above correspond to a mass spectrometry method using the sample support 1.

### Effects

In the sample support 1 described above, the particles 31A of the plurality of particles 31 constituting the porous structure 3, which constitute the first surface 2a (that is, the particles 31 located in the outermost layer on the first surface 2a side), have the rough surface 31a on which the uneven structure 4 is formed on the first surface 2a side. By providing such an uneven structure 4, the sample Sa to be measured can be suitably retained on the rough surface 31a. More specifically, the uneven structure 4 has outwardly pointed convex portions 4a (see FIG. 5). Since the sample Sa is likely to be caught on edge portions of such convex portions 4a, the sample Sa can be suitably retained on the rough surface 31a. Also, for example, when the sample Sa is a biological cell or the like, the convex portions 4a can break a cell membrane of the sample Sa, and a component Sa1 of the sample Sa therein can be suitably spread over the surface of the rough surface 31a. That is, the transfer efficiency when the sample Sa is brought into contact with and transferred to the first surface 2a of the substrate 2 can be improved. In addition, the plurality of convex portions 4a and concave portions 4b make the rough surface 31a less slippery compared to the smooth non-rough surface 31b. As a result, lateral slip of the sample Sa transferred to the rough surface 31a can be suppressed.

On the other hand, a surface of the particle 31A opposite to the rough surface 31a is the non-rough surface 31b on which the uneven structure 4 is not formed. This allows excess liquid components contained in the sample Sa to suitably permeate from the first surface 2a side to the second surface 2b side. That is, by making the back surface (lower surface) of the particle 31A a smooth curved surface (non-rough surface 31b) through which a liquid can permeate more smoothly than the rough surface 31a on which the uneven structure 4 is formed, the function of permeating the liquid into the inside of the substrate 2 can be improved. As a result, it is possible to suppress the measurement (ionization of the component Sa1 of the sample Sa retained on the first surface 2a) from being hindered by an excess liquid component overflowing on the first surface 2a.

For the reasons stated above, according to the sample support 1, since the component Sa1 of the sample Sa retained on the first surface 2a can be efficiently ionized, the detection sensitivity of the component Sa1 of the sample Sa can be effectively improved. Furthermore, since the sample Sa is easily retained on the first surface 2a as described above, an area on the first surface 2a stained by the sample Sa becomes larger and the stain becomes darker. This improves the visibility of the sample Sa attached to the measurement surface (first surface 2a) of the sample support 1, and also facilitates work such as determining an irradiation range of the micro-droplets I for ionization.

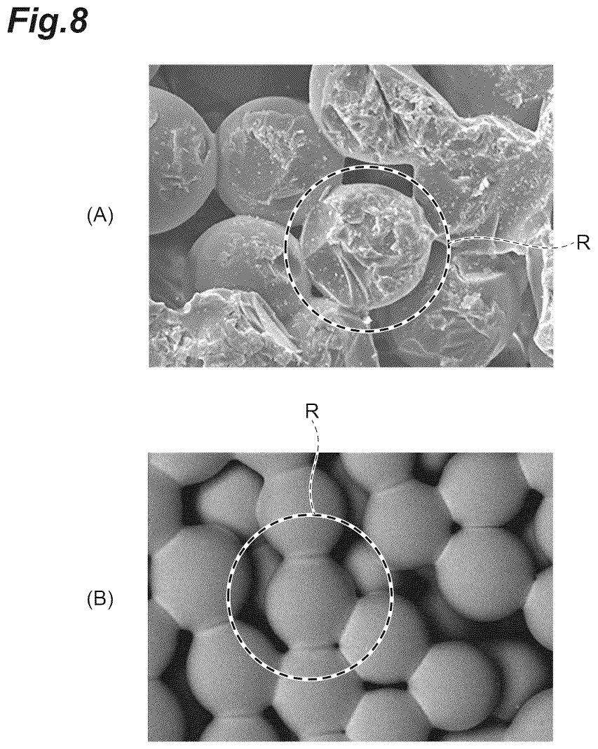

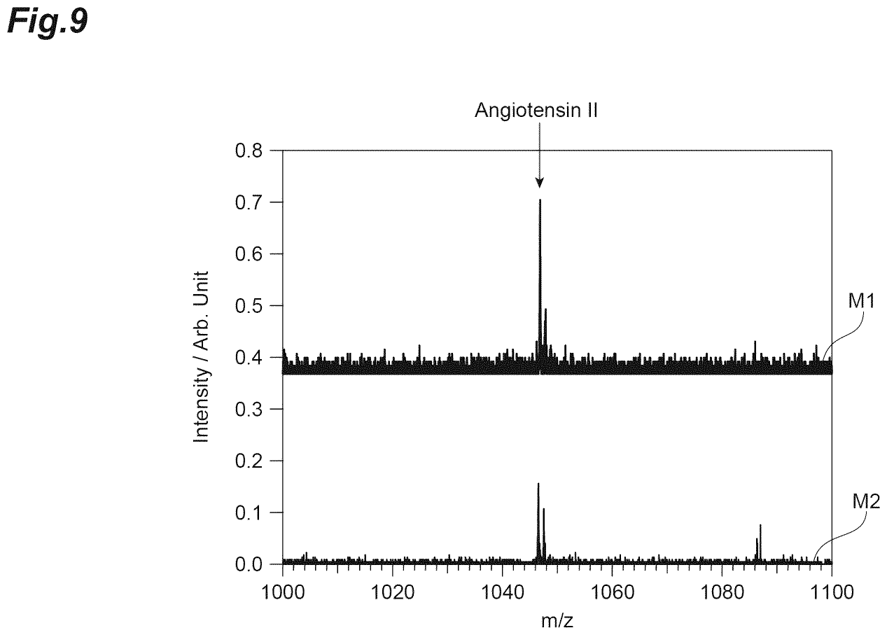

The above effects will be supplemented with reference to FIGS. 8 and 9. In the examples of FIGS. 8 and 9, by providing a conductive layer 5 described later, laser desorption/ionization, in which ionization is performed by irradiating a laser beam instead of the micro-droplets I, is used instead of the desorption electrospray ionization method of the above embodiment. However, (A) and (B) of FIG. 8 show states before the conductive layer 5 is provided in an example and a comparative example. (A) of FIG. 8 shows an example of one irradiation range R of a laser beam in the example (that is, a sample support 1C including a conductive layer 5 described later). (B) of FIG. 8 shows an example of one irradiation range R of a laser beam in the comparative example. The sample support according to the comparative example has a substrate (porous structure) configured by a plurality of particles 31 similarly to the example, but is different from the example in that the upper surfaces of the plurality of particles 31A constituting the first surface 2a are not formed as the rough surface 31a.

FIG. 9 shows mass spectra obtained by performing mass spectrometry (laser desorption/ionization method) of a sample Sa (as an example, Angiotensin II) using each of the above example and comparative example. That is, in FIG. 9, a horizontal axis represents a mass-to-charge ratio (m/z), and a vertical axis represents a signal intensity (arbitrary unit: arb. unit). FIG. 9 shows a mass spectrum M1 of the example and a mass spectrum M2 of the comparative example. In order to facilitate comparison between the mass spectrum M1 of the example and the mass spectrum M2 of the comparative example, an origin of the signal intensity of the mass spectrum M1 of the example (that is, a value corresponding to a signal intensity “0”) is shifted upward (by about +0.37). The mass spectra M1 and M2 are normalized with a peak intensity of sodium citrate in each of the example and the comparative example as 100% (1.0). As shown in FIG. 9, according to the example, a higher signal intensity was obtained at a position corresponding to the sample Sa (Angiotensin II) than in the comparative example. That is, it was confirmed that according to the example, since the component Sa1 of the sample Sa is more easily retained on the first surface 2a than in the comparative example, the detection sensitivity of the component Sa1 of the sample Sa is remarkably improved. As described above, FIG. 9 shows a measurement result when the laser desorption/ionization method is performed using the sample support including the conductive layer 5, but it is considered that a similar result can be obtained even when mass spectrometry by the desorption electrospray ionization method described above (the first to fourth steps described above) is performed using a sample support not including the conductive layer 5. That is, since the component Sa1 of the sample Sa is more easily retained on the first surface 2a in the example (sample support 1) than in the comparative example (that is, a sample support in which the upper surfaces of the plurality of particles 31A constituting the first surface 2a are not formed as the rough surface 31a), it is considered that high detection sensitivity can be obtained in the mass spectrometry by the desorption electrospray ionization method described above (the first to fourth steps described above).

In the ionization method described above, in the third step, the irradiation region I1 of the charged micro-droplets I is relatively moved with respect to the first surface 2a. In the component Sa1 of the sample Sa retained on the first surface 2a side of the substrate 2, position information of the sample Sa (two-dimensional distribution information of molecules (component Sa1) constituting the sample Sa) is maintained. Therefore, by relatively moving the irradiation region I1 of the charged micro-droplets I with respect to the first surface 2a (target region), the component Sa1 of the sample Sa can be ionized while maintaining the position information of the sample Sa. This makes it possible to image the two-dimensional distribution of the molecules constituting the sample Sa in a subsequent step of detecting the sample ions Sa2. Furthermore, since the nozzle 42 can be brought close to the first surface 2a as described above, it is possible to suppress the irradiation region I1 of the charged micro-droplets I from expanding. This makes it possible to image the two-dimensional distribution of the molecules constituting the sample Sa with high resolution in a subsequent step of detecting the sample ions Sa2.

In the mass spectrometry method using the sample support 1, as described above, since the component Sa1 of the sample Sa is suitably ionized by irradiation with the charged micro-droplets I, the signal intensity when detecting the sample ions Sa2 can be improved.

### MODIFICATIONS

The present disclosure is not limited to the embodiments described above. Various materials and shapes can be adopted for the material and shape of each component, not limited to the materials and shapes described above. In addition, some of the configurations included in the sample support 1 according to the above embodiment may be omitted or changed as appropriate. For example, in the above embodiment, some characteristic configurations included in the sample support 1 and some effects exhibited by each configuration have been described, but the sample support according to the present disclosure does not necessarily have to be configured to exhibit all the effects described in the above embodiment, and may be configured to exhibit only some of the effects described in the above embodiment. In the latter case, the sample support only needs to be provided with a configuration essential for exhibiting that part of the effects, and a configuration not essential for exhibiting that part of the effects may be omitted or changed as appropriate. When focusing on one effect, the configuration essential for exhibiting the one effect should be reasonably grasped by a person skilled in the art based on common general knowledge and the description of the present specification. Hereinafter, some modifications of the sample support of the present disclosure will be exemplified.

### First Modification

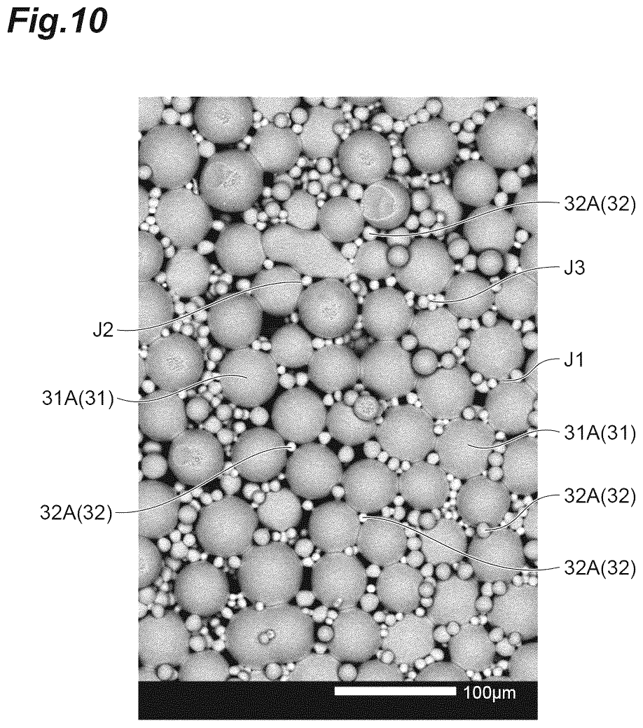

A sample support 1A according to a first modification will be described with reference to FIGS. 10 to 12. The sample support 1A is different from the sample support 1 in that it includes a substrate 2A made of a porous structure 3A instead of the substrate 2 made of the porous structure 3. The porous structure 3A further includes a plurality of small particles 32 (second particles) each having a diameter smaller than that of the particles 31. At least a part of the plurality of small particles 32 is held between two or more of the particles 31A in the outermost layer on the first surface 2a side of the porous structure 3A.

The porous structure 3A is formed of a plurality of particles 31 (first particles) connected to each other and a plurality of small particles 32 (second particles) having a diameter smaller than that of the particles 31. The small particles 32 are formed of the same material as the particles 31. In the present embodiment, the particles 31 and the small particles 32 are formed of the same insulating material. For example, the particles 31 and the small particles 32 are formed of glass. In the present embodiment, from the viewpoint of facilitating the manufacture of the aggregate structure, soda glass having a relatively low melting point among glasses is used as the material of the particles 31 and the small particles 32. The particles 31 and the small particles 32 are both spherical beads (glass beads).

FIG. 10 is an SEM image obtained by capturing the substrate 2A in a state before the rough surface 31a of the particle 31A and the rough surface 32a of an outermost layer of small particles 32A (the outermost layer of small particles 32 on the first surface 2a side) described later are formed, from a direction facing the first surface 2a. As shown in FIG. 10, although there are slight variations in shape and size for each particle, each of the plurality of particles constituting the porous structure 3A can be classified as either a particle 31 or a small particle 32 even by visual observation. That is, the porous structure 3 is configured by a particle group that can be clearly distinguished into two groups in terms of “size”. More specifically, each of the plurality of particles 31 has some variation in shape and size, but has a diameter larger than the small particles 32 to an extent that can be distinguished at least from the SEM image, and is distinguishable from the small particles 32. Similarly, each of the plurality of small particles 32 has some variation in shape and size, but has a diameter smaller than the particles 31 to an extent that can be distinguished at least from the SEM image, and is distinguishable from the particles 31.

When the first surface 2a is viewed from a position facing the first surface 2a along the direction D1, the following formula (1) is satisfied, where R1 is an average particle size of the particles 31 included in a unit area of a predetermined size (for example, a region of several hundred μm to 1 mm square), and R2 is an average particle size of the small particles 32 included in the unit area. More preferably, the following formula (2) is satisfied.

$$R 1 \times 1 / 100 \leq R 2 \leq R 1 \times 1 / 2 \qquad ( 1 )$$

$$R 1 \times 1 / 10 \leq R 2 \leq R 1 \times 2 / 5 \qquad ( 2 )$$

The average particle sizes R1 and R2 can be calculated based on, for example, an SEM image as shown in FIG. 10. For example, first, all spherical objects are extracted by performing known image processing (edge detection or the like) on the SEM image of FIG. 10. The objects may be extracted by visual observation instead of the image processing. Subsequently, an object having a maximum diameter is extracted from the plurality of extracted objects, and objects having a diameter with an error of a certain value or less (for example, 30% or less of the maximum diameter) with respect to the maximum diameter are classified as large particles (particles 31). Subsequently, those of the plurality of objects that are not classified as the particles 31 and remain are classified as the small particles 32. Subsequently, an average diameter of the plurality of objects classified as the particles 31 is calculated as the average particle size R1 of the particles 31, and an average diameter of the plurality of objects classified as the small particles 32 is calculated as the average particle size R2 of the small particles 32. The average particle sizes R1 and R2 can be calculated by the processing described above. The calculation method described above is an example, and the average particle sizes R1 and R2 may be calculated by other methods. As an example, the average particle size R1 of the particles 31 is about 50 μm, and the average particle size R2 of the small particles 32 is about 5 μm to 20 μm.

As shown in FIG. 10, the first surface 2a of the substrate 2A is configured by surfaces (upper surfaces) of the particles 31A and the small particles 32A located on the uppermost surface (outermost layer) when a direction from the second surface 2b toward the first surface 2a is defined as an upward direction. A black portion in FIG. 10 is a portion where the particles 31A and the small particles 32A constituting the first surface 2a do not exist, and corresponds to a gap (opening) between the particles. When the first surface 2a is viewed from a position facing the first surface 2a along the direction D1, in a unit area of a predetermined size (for example, a region of several hundred μm to 1 mm square), it is preferable that an area occupied by the particles 31 is the largest, and then an area occupied by the small particles 32 is larger than an area occupied by the gaps (openings) between the particles. The porous structure 3A is open to the first surface 2a at such openings. A liquid that has penetrated into the porous structure 3A from the openings of the first surface 2a can pass through the inside of the porous structure 3A and exit to the outside of the second surface 2b from openings on the second surface 2b side. That is, in the present embodiment, the porous structure 3A is open to both the first surface 2a and the second surface 2b, and the openings of the first surface 2a and the openings of the second surface 2b communicate with each other via the gaps between the particles inside the porous structure 3A.

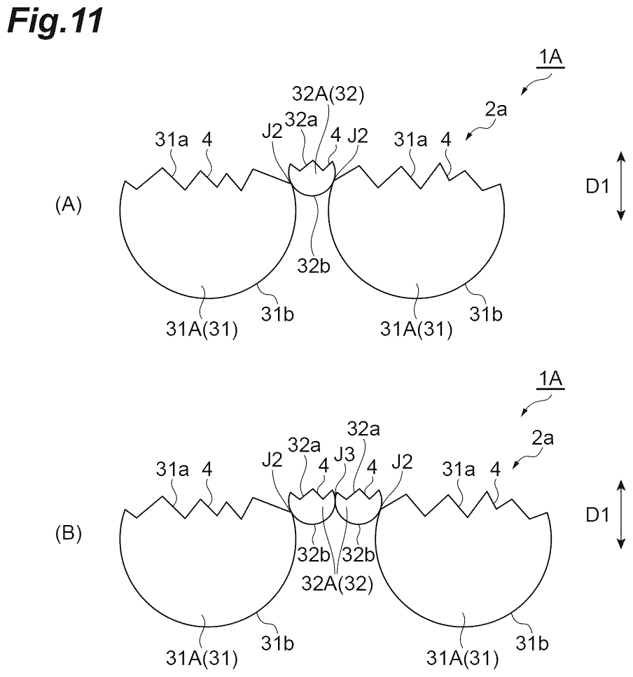

As shown in FIG. 10, at least a part of the plurality of small particles 32 included in the porous structure 3A, that is, small particles 32A (outermost second particles) constituting the first surface 2a together with the particles 31A, is held between two or more of the particles 31A. Examples of the form in which the small particles 32A are held by two or more of the particles 31A include a form in which one small particle 32A is held between two particles 31A as shown in (A) of FIG. 11, and a form in which a plurality of (two in this example) small particles 32A in contact with each other are held between two particles 31A as shown in (B) of FIG. 11. However, the form in which the small particles 32A are held by two or more of the particles 31A is not limited to the above examples. As shown in FIGS. 10 and 11, the porous structure 3A has a configuration in which one or more small particles 32A are held by two or more particles 31A constituting the first surface 2a, thereby having a joint J1 between particles 31A, a joint J2 between a particle 31A and a small particle 32A, and a joint J3 between small particles 32A on the first surface 2a.

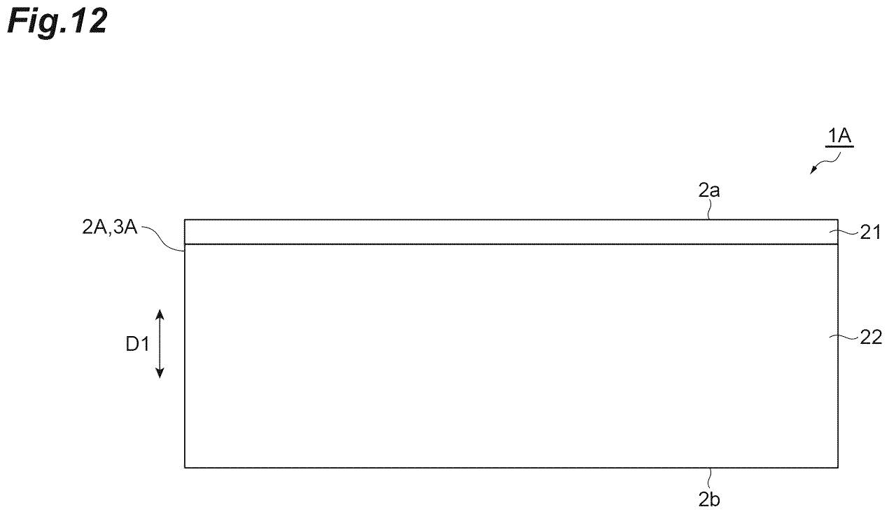

Here, most of the plurality of small particles 32 are distributed on the first surface 2a (that is, between the particles 31A constituting the first surface 2a), and do not exist inside the substrate 2 (porous structure 3A) at a position spaced a certain distance or more from the first surface 2a toward the second surface 2b. That is, as shown in FIG. 12, when a layer structure of the substrate 2A configured by the porous structure 3A is schematically represented, the substrate 2A has a mixed layer 21 (first layer) and a large particle layer 22 (second layer). The mixed layer 21 is a layer including the first surface 2a, in which a plurality of the particles 31 and a plurality of the small particles 32 coexist. The large particle layer 22 is a layer located closer to the second surface 2b than the mixed layer 21, consisting of a plurality of the particles 31, and not including the small particles 32.

A thickness of the mixed layer 21 in the direction D1 is one-fifth or less of a thickness of the large particle layer 22 in the direction D1. In the present embodiment, as an example, the thickness of the mixed layer 21 is about one-tenth of the total thickness of the substrate 2A (porous structure 3A). That is, the thickness of the mixed layer 21 is about one-ninth of the thickness of the large particle layer 22.

As shown in (A) and (B) of FIG. 11, in the present embodiment, the small particles 32A located in the outermost layer and constituting the first surface 2a have a rough surface 32a on which the uneven structure 4 is formed on the first surface 2a side, and a non-rough surface 32b on which the uneven structure 4 is not formed on the second surface 2b side. The rough surface 32a and the non-rough surface 32b have the same configuration as the rough surface 31a and the non-rough surface 31b of the particle 31A described above, respectively.

The sample support 1A (porous structure 3A) is manufactured, for example, as follows. First, a plurality of particles 31 are sintered to obtain a sintered body (first sintering step). Specifically, in a state where the plurality of particles 31 are pressed and compacted by a press machine or the like, the surfaces of the plurality of particles 31 are fused by being heated at a high temperature equal to or lower than the melting point of the particles 31, whereby they are bonded to each other, and a sintered body consisting only of the plurality of particles 31 is obtained. The sintered body has substantially the same outer shape as the finally obtained substrate 2A. Subsequently, a plurality of small particles 32 are added to a surface of the sintered body corresponding to the first surface 2a (that is, a surface scheduled to finally become the first surface 2a) (adding step). For example, the plurality of small particles 32 are sprinkled on the surface of the sintered body. Subsequently, by sintering (re-sintering) in a state where the sintered body and the plurality of small particles 32 added to the sintered body coexist, a second sintered body in which the surfaces of the plurality of particles 31 and the plurality of small particles 32 are fused together is obtained (second sintering step). Subsequently, a roughening step similar to the method for manufacturing the sample support 1 described above is performed on the second sintered body. This allows the upper surface of each of the plurality of particles 31A and the plurality of small particles 32A to be the rough surfaces 31a and 32a. As a result, the porous structure 3A described above is obtained.

According to the sample support 1A, in addition to the effects of the sample support 1 described above, the following effects are exhibited. That is, in the sample support 1A, the porous structure 3A includes not only the plurality of particles 31 but also the small particles 32A held between two or more of the particles 31A. This can reduce a gap (that is, a space where no particles constituting the porous structure 3A exist) of the sample support 1A on the first surface 2a when the sample support 1A is viewed from a position facing the first surface 2a. That is, as can be seen from the SEM image of FIG. 10, the gaps between the particles 31A in the outermost layer are filled by holding the small particles 32A between the plurality of particles 31A in the outermost layer. In addition, as shown in FIGS. 10 and 11, on the first surface 2a, not only a joint J1 between the particles 31A but also a joint J2 between the particle 31A and the small particle 32A and a joint J3 between the small particles 32A are also formed. The sample Sa transferred or dropped onto the first surface 2a is particularly likely to be retained at such joints J1, J2, and J3. That is, by increasing such joints J1, J2, and J3, the sample Sa to be measured can be suitably retained on the first surface 2a (particularly on the joints J1, J2, and J3 described above). Therefore, according to the sample support 1A, since a component Sa1 of the sample Sa retained on the first surface 2a can be efficiently ionized, the detection sensitivity of the component Sa1 of the sample Sa (that is, the detection sensitivity of the sample ion Sa2) in mass spectrometry using the sample support 1A (for example, the first to fourth steps in the above embodiment) can be more effectively improved. Furthermore, since the sample Sa is easily retained on the first surface 2a as described above, a region where the sample Sa is stained on the first surface 2a becomes larger and the stain becomes darker. This improves the visibility of the sample Sa attached to the measurement surface (first surface 2a) of the sample support 1A, and also facilitates work such as determining an irradiation range of the micro-droplets I for ionization.

As shown in (A) and (B) of FIG. 11, in the sample support 1A, the small particles 32A have the rough surface 32a on the first surface 2a side and the non-rough surface 32b on the second surface 2b side. According to this configuration, not only the particles 31A but also a surface on the first surface 2a side of the small particles 32A held between two or more of the particles 31A is configured as the rough surface 32a, so that the sample Sa to be measured can be more suitably retained on the first surface 2a. As a result, the detection sensitivity of the component Sa1 of the sample Sa can be more effectively improved.

In the sample support 1A, the small particles 32 are formed of the same material as the particles 31. If the particles 31 and the small particles 32 are formed of different materials from each other, a signal derived from a material (material of the small particles 32) different from a base material (material of the particles 31) may be generated as noise during ionization (in the present embodiment, during ionization of the component Sa1 by irradiation with the micro-droplets I). In contrast, by forming the particles 31 and the small particles 32 of the same material as in the present embodiment, the occurrence of such a problem can be avoided. In addition, since the melting points and the coefficients of thermal expansion of the particles 31 and the small particles 32 are equal, the second sintering step described above can be easily performed (that is, can be performed under the same temperature conditions as the first sintering step), so that the substrate 2A (porous structure 3A) can be manufactured easily and with stable quality.

In the sample support 1A, the particles 31 and the small particles 32 are formed of an insulating material. According to this configuration, the substrate 2A in which the plurality of particles 31 and the plurality of small particles 32 are integrated can be manufactured by a simple method such as sintering. In addition, since the substrate 2A can be made insulating, the sample support 1A suitable for the desorption electrospray ionization method described above can be realized. In the present embodiment, the particles 31 and the small particles 32 are formed of glass. According to this configuration, by forming the particles 31 and the small particles 32 with glass having a relatively low melting point, a heating temperature required for the first sintering step and the second sintering step described above can be relatively lowered, so that the substrate 2A having the porous structure 3A can be suitably and inexpensively obtained.

In the sample support 1A, the sizes of the plurality of particles 31 and the plurality of small particles 32 included in the porous structure 3A are adjusted so as to satisfy the above formula (1) (that is, “R1× 1/100≤R2≤R1×½”). According to this configuration, a configuration in which one or more small particles 32 are held between two or more particles 31 constituting the first surface 2a can be suitably realized. As a result, the effect of improving the detection sensitivity as described above can be suitably obtained. From the viewpoint of more suitably realizing the configuration in which the small particles 32 are held between the particles 31 as described above, it is more preferable to satisfy the above formula (2) (that is, “R1× 1/10≤R2≤R1×⅖”).

In the sample support 1A, the substrate 2A has the mixed layer 21 including the first surface 2a, and the large particle layer 22 located on the second surface 2b side with respect to the mixed layer 21. That is, in the sample support 1A, while the mixed layer 21 in which the particles 31 and the small particles 32 are mixed is provided to easily retain the sample Sa on the first surface 2a, the large particle layer 22, through which a liquid can pass more easily than through the mixed layer 21 because it does not include the small particles 32, is provided below the mixed layer 21 (on the second surface 2b side). This allows the liquid component to appropriately escape from the mixed layer 21 to the large particle layer 22, for example, when a sample Sa to be measured containing a liquid component is transferred or dropped onto the first surface 2a of the sample support 1A. As a result, it is possible to suppress an excess liquid component from overflowing on the first surface 2a, and to suppress the measurement (that is, ionization of the component Sa1 of the sample Sa retained on the first surface 2a) from being hindered by the generation of such an excess liquid component.

In the sample support 1A, a thickness of the mixed layer 21 in the direction D1 is one-fifth or less of a thickness of the large particle layer 22 in the direction D1. According to this configuration, by sufficiently securing the thickness of the large particle layer 22 with respect to the mixed layer 21, the effect described above (that is, the effect of allowing a liquid component that may hinder measurement to escape from the mixed layer 21 to the large particle layer 22) can be suitably obtained.

### Second Modification

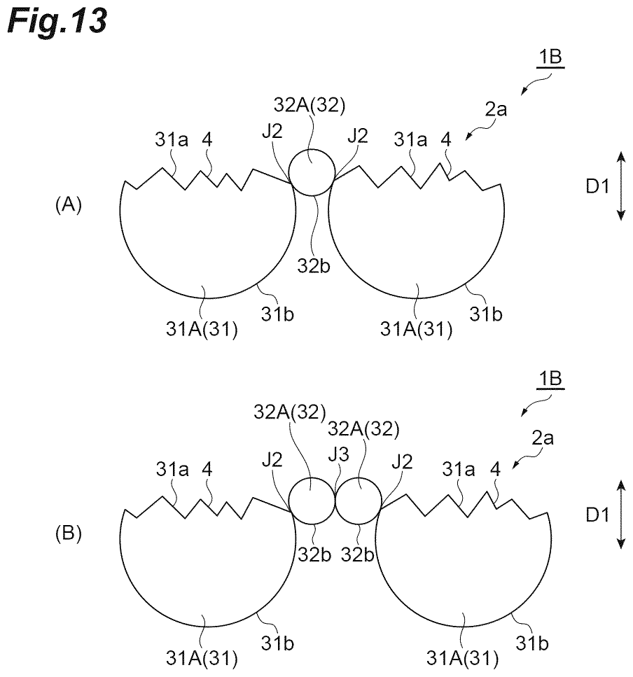

A sample support 1B according to a second modification will be described with reference to FIG. 13. The sample support 1B is different from the sample support 1A in that the uneven structure 4 is not formed on either a surface on the first surface 2a side or a surface on the second surface 2b side of the small particles 32A that constitute the first surface 2a. That is, as shown in (A) and (B) of FIG. 13, in the sample support 1B, the entire surface of the small particle 32A is configured as the non-rough surface 32b.

The sample support 1B is manufactured, for example, as follows. First, the method for manufacturing the sample support 1 described above is performed to obtain the sample support 1. Subsequently, a plurality of small particles 32 are added to the first surface 2a of the sample support 1 (adding step). For example, the plurality of small particles 32 are sprinkled on the surface of the sintered body. Subsequently, sintering (re-sintering) is performed in a state where the sample support 1 and the plurality of small particles 32 coexist (second sintering step). As a result, the porous structure of the second modification described above is obtained. As described above, in the method for manufacturing the sample support 1B, the roughening treatment is performed only on the particles 31A, and the roughening treatment is not performed on the small particles 32A.

According to the sample support 1B, similarly to the sample support 1A, by increasing the joints J2 and J3 in addition to the joint J1, the sample Sa to be measured can be suitably retained on the first surface 2a (particularly on the joints J1, J2, and J3 described above). The sample support 1A (porous structure 3A) according to the first modification described above is obtained by performing a treatment similar to the roughening treatment on the surface of the particles 31A also on the surface (the surface on the first surface 2a side) of the small particles 32A, which have a smaller diameter than the particles 31A. Here, since the small particles 32A are smaller and more brittle than the particles 31A, the small particles 32A may be crushed and enter the inside of the porous structure 3A in the roughening treatment. As a result, the effect of the sample support 1A described above (that is, the effect of the small particles 32A being held between two or more of the particles 31A) may be reduced. In contrast, according to the sample support 1B, since the roughening treatment is performed only on the surface of the particles 31A and the roughening treatment is not performed on the small particles 32A, the above-described problem can be avoided.

### Third Modification

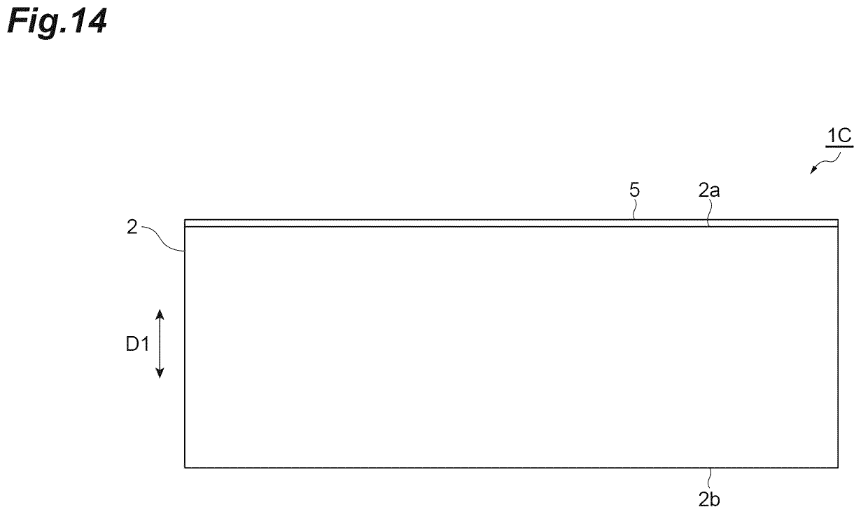

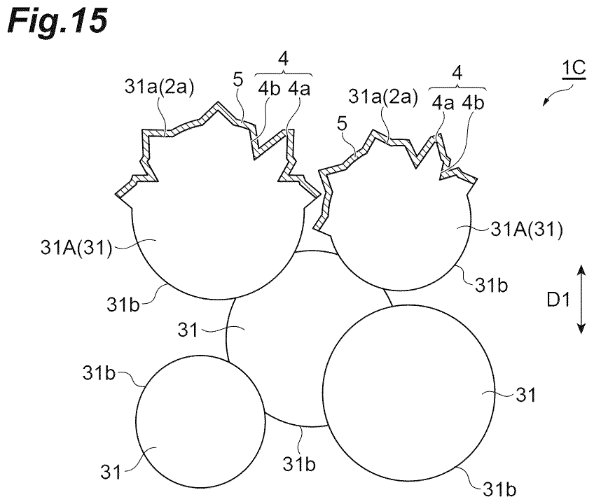

A sample support 1C according to a third modification will be described with reference to FIGS. 14 and 15. The sample support 1C is different from the sample support 1 in that it includes a conductive layer 5. The sample support 1C, by including the conductive layer 5, can be used for an ionization method (for example, a laser desorption/ionization method, or the like) that requires applying a voltage to the first surface 2a to detect the component Sa1 of the ionized sample Sa.

The conductive layer 5 covers the first surface 2a without blocking the openings of the porous structure 3 on the first surface 2a. That is, the conductive layer 5 is provided so as not to completely block the openings (gaps between particles) of the porous structure 3 on the first surface 2a. As a result, also in the sample support 1C, a liquid component contained in the sample Sa transferred or dropped onto the first surface 2a (strictly speaking, onto the conductive layer 5 formed on the first surface 2a) can penetrate into the porous structure 3.

In addition, the conductive layer 5 covers the first surface 2a along a surface shape of the uneven structure 4 of the particle 31A. That is, a thickness of the conductive layer 5 is made very thin with respect to the size (diameter) of the particle 31A. As a result, a shape of an outer surface of the conductive layer 5 formed on the surface of the particle 31A follows the surface shape (uneven shape) of the uneven structure 4. Therefore, as shown in FIG. 15, even in a state after the conductive layer 5 is formed, the uneven shape of the first surface 2a (that is, the uneven shape of the rough surface 31a of each particle 31A) is maintained.

The conductive layer 5 is formed of a conductive material. As a material of the conductive layer 5, it is preferable to use a metal having low affinity (reactivity) with the sample Sa and high conductivity. From such a viewpoint, as the material of the conductive layer 5, for example, Au (gold), Pt (platinum), or the like is preferably used. The conductive layer 5 is formed to a thickness of about 1 nm to 350 nm by, for example, a plating method, an atomic layer deposition (ALD) method, a vapor deposition method, a sputtering method, or the like. Note that, as the material of the conductive layer 5, for example, Cr (chromium), Ni (nickel), Ti (titanium), or the like may be used.

As shown in FIG. 15, the conductive layer 5 is formed to cover the rough surface 31a exposed on the first surface 2a side among the surfaces of the particles 31A constituting the first surface 2a, for example, by performing the vapor deposition method, the sputtering method, or the like described above from the first surface 2a side. On the other hand, when the conductive layer 5 is formed by ALD, the conductive layer 5 enters the gaps of the porous structure 3, and thus can be formed not only on the surface exposed on the first surface 2a side but also on a surface of the particle 31A facing the second surface 2b side (the non-rough surface 31b) and on a surface of the particle 31 present inside the porous structure 3 (the non-rough surface 31b). That is, the conductive layer 5 may be formed to cover at least the surface (the rough surface 31a) exposed on the first surface 2a side of the particles 31A constituting the first surface 2a, and may also be formed on the surfaces of other particles 31.

According to the sample support 1C, it is possible to obtain the same effects as the sample support 1 (that is, without impairing the effects of the sample support 1 due to the presence of the conductive layer 5), and the sample support 1C can be used for a laser desorption/ionization method or the like. More specifically, when a laser desorption/ionization method or the like is used, that is, when it is necessary to apply a voltage to the first surface 2a to guide the component Sa1 of the sample Sa ionized on the first surface 2a to an ion detector (ground electrode side), a voltage can be appropriately applied via the conductive layer 5.

### Fourth Modification

In the sample support 1, particles 31 of the plurality of particles 31 that constitute the second surface 2b may have a rough surface 31a on which the uneven structure 4 is formed on the second surface 2b side, and a non-rough surface 31b on which the uneven structure 4 is not formed on the first surface 2a side. That is, the sample support 1 may have a symmetrical structure in the direction D1. In other words, a portion on the first surface 2a side and a portion on the second surface 2b side may have the same configuration.

According to the fourth modification described above, both the first surface 2a and the second surface 2b can be used as a measurement surface (that is, a surface that supports the sample Sa to be measured) that exhibits the effects of the sample support 1 described above. This improves convenience because a user (measurer) of the sample support 1 does not need to identify which surface of the sample support 1 is the measurement surface when transferring or dropping the sample Sa to be measured onto the sample support 1.

### Other Modifications

The configurations of the above-described embodiment and the first to fourth modifications may be combined as appropriate. For example, the first modification and the third modification may be combined. In this case, the conductive layer 5 is provided on each of the upper surface (rough surface 31a) of the particle 31A and the upper surface (rough surface 32a) of the small particle 32A of the sample support 1A (see FIG. 11). Also, the second modification and the third modification may be combined. In this case, the conductive layer 5 is provided on each of the upper surface (rough surface 31a) of the particle 31A and the upper surface (non-rough surface 32b) of the small particle 32A of the sample support 1B (see FIG. 13). Also, the first or second modification and the fourth modification may be combined. In this case, a third layer similar to the mixed layer 21 (that is, a layer in which the particles 31 and the small particles 32 coexist) is also formed on the second surface 2b side. In this case, the large particle layer 22 in the sample supports 1A and 1B is located between the mixed layer 21 on the first surface 2a side and the third layer.

In the first and second modifications, the porous structure 3A has a configuration in which the small particles 32A are held between two or more of the particles 31A constituting the first surface 2a by fusing the plurality of particles 31 and the plurality of small particles 32 to each other, but the small particles 32A do not necessarily have to be fused with the adjacent particles 31A.

In the above embodiment, the sample support 1 was configured to include only the substrate 2, but the sample support 1 may include members other than the substrate 2. For example, a support member (a frame or the like) for supporting the substrate 2 may be provided at a part (for example, a corner or the like) of the substrate 2.

The sample Sa is not limited to the slice of the fruit (lemon) exemplified in the above embodiment. The sample Sa may have a flat surface or an uneven surface. The sample Sa may be other than a fruit, and may be, for example, a leaf of a plant or the like. In this case, by transferring components of the surface of the leaf, which is the sample Sa, to the first surface 2a, imaging mass spectrometry of the surface (leaf vein) of the leaf can be performed.

In the above embodiment, the entire substrate 2 is configured by the porous structure 3, but the porous structure 3 may be formed in a part of the substrate 2. For example, the porous structure 3 may be formed only in a central region (a partial region of the first surface 2a) defined as a measurement region for transferring or dropping the sample Sa in the substrate 2. In this case, the porous structure 3 may not be formed in other portions of the substrate 2. In addition, the porous structure 3 does not have to be formed over the entire region from the first surface 2a to the second surface 2b. That is, the porous structure 3 only needs to be open to at least the first surface 2a, and does not have to be open to the second surface 2b. For example, the substrate 2 may be configured by a flat plate including the second surface 2b, and the porous structure 3 provided on a surface of the plate opposite to the second surface 2b. As an example, the substrate 2 may be configured by a glass plate and a sintered body of glass beads (porous structure 3) provided on the glass plate.

In the above embodiment, the first surface 2a had insulating properties so that the sample support 1 can be used for a desorption electrospray ionization method. More specifically, the substrate 2 (porous structure 3) itself was formed of an insulating material, so that the first surface 2a had insulating properties. However, the sample support 1 can be configured to be usable for the desorption electrospray ionization method by a configuration other than the above. For example, the substrate 2 (porous structure 3) may be formed of a conductive material. In this case, a configuration in which the first surface 2a has insulating properties may be realized by applying an insulating coating to the first surface 2a of the substrate 2. By applying such an insulating coating, the first surface 2a of the substrate 2 can be made insulating, so that it becomes possible to use the substrate 2 formed of a conductive material. For example, in this case, the porous structure 3 may be formed by an aggregate of a plurality of particles 31 made of metal. As described above, when an insulating coating is provided, the degree of freedom in selecting a substrate material (that is, a material of the particles 31) can be improved.

As a material of the particles 31 and 32 described above, in addition to the insulating material exemplified in the above embodiment (as an example in the above embodiment, glass (soda glass)), a metal oxide (for example, alumina or the like), or a metal with an insulating coating or the like may be used. The shapes of the particles 31 and 32 are not limited to a spherical shape, and may have a shape other than a spherical shape. In the latter case, the diameter (average particle sizes R1, R2) of the particles 31 and 32 described in the above embodiment may be interpreted as an effective diameter of the particles observed when the substrate 2 is viewed from a position facing the first surface 2a along the direction D1 (that is, a maximum diameter of a virtual cylinder that is inscribed in a region occupied by the particles).

Reference Signs List

1, 1A, 1B, 1C: sample support, 2, 2A: substrate, 2a: first surface,
2b: second surface, 3, 3A: porous structure, 4: uneven structure, 5:
conductive layer, 21: mixed layer (first layer), 22: large particle layer
(second layer), 31: particle (first particle), 31a: rough surface, 31b: non-
rough surface, 31A: particle (outermost first particle), 32: small particle
(second particle), 32a: rough surface, 32b: non-rough surface, 32A: small
particle (outermost second particle), Sa: sample, Sal: component, Sa2:
sample ion (ionized component).

1. A sample support for ionization a sample, comprising:
a substrate having a first surface, a second surface opposite to the first surface, and an irregular porous structure opening to the first surface,
wherein the porous structure is formed by a plurality of first particles connected to each other, and
outermost first particles of the plurality of first particles, which constitute the first surface, have a rough surface on which an uneven structure is formed on a first surface side, and a non-rough surface on which the uneven structure is not formed on a second surface side.

2. The sample support according to claim 1, wherein
the porous structure further comprises a plurality of second particles each having a diameter smaller than that of the first particles, and
at least a part of the plurality of second particles is held between two or more of the outermost first particles.

3. The sample support according to claim 2, wherein
outermost second particles of the plurality of second particles, which constitute the first surface, have a rough surface on which the uneven structure is formed on a first surface side, and a non-rough surface on which the uneven structure is not formed on a second surface side.

4. The sample support according to claim 2, wherein the uneven structure is formed on neither a surface on a first surface side nor a surface on a second surface side of outermost second particles of the plurality of second particles that constitute the first surface.

5. The sample support according to claim 2, wherein the substrate comprises:
a first layer including the first surface and in which a plurality of the first particles and a plurality of the second particles coexist; and
a second layer located closer to the second surface than the first layer, consisting of a plurality of the first particles, and not including the second particles.

6. The sample support according to claim 1, wherein
particles of the plurality of first particles that constitute the second surface have a rough surface on which an uneven structure is formed on a second surface side, and a non-rough surface on which the uneven structure is not formed on a first surface side.

7. The sample support according to claim 1, further comprising a conductive layer that covers the first surface along a surface shape of the uneven structure of the outermost first particles without blocking openings of the porous structure on the first surface.

8. A method for manufacturing the sample support according to claim 1, comprising:
a sintering step of sintering the plurality of first particles to obtain a sintered body having substantially same outer shape as the substrate; and
a roughening step of performing a roughening treatment on a surface of the sintered body corresponding to the first surface, thereby forming a plurality of the outermost first particles, each having the rough surface formed on the first surface side.
